(19) United States
(12) Patent Application Publication
(10) Pub. No.: US 2020/0148232 A1
(43) Pub. Date: May 14, 2020

(54) Unmanned Aerial/Ground Vehicle (UAGV) Detection System and Method

(71) Applicant: Walmart Apollo, LLC, Bentonville, AR (US)

(72) Inventors: Michael Kenneth Morrison, Bella Vista, AR (US); Mary Ann Phillips, Bella Vista, AR (US); Aditya Reddy Cheruku, Bentonville, AR (US); James Gosserand, Rogers, AR (US)

(21) Appl. No.: 15/883,346

(22) Filed: Jan. 30, 2018

Related U.S. Application Data
(60) Provisional application No. 62/467,510, filed on Mar. 6, 2017.
(60) Provisional application No. 62/459,876, filed on Feb. 16, 2017.

(51) Int. Cl. B60W 60/00; G05D 1/02; G05D 1/00

(52) U.S. Cl. CPC B60W 60/00259; B60W 60/00256; G05D 1/0219; G05D 2201/0216; G05D 1/0094; G05D 1/0016; G05D 2201/0207; G05D 1/0246

(57) ABSTRACT

An issue reporting and detection system is discussed. A user can capture an image with a mobile device of an issue at a location in a facility. An application executing on the mobile device can receive an input associated with the image. The mobile application can transmit image and the input associated with the image to a computing system which can determine a location at which the image was taken in the facility. The computing system can transmit a command to a UAGV to navigate to the determined location of the facility where the UAGV can capture an image using an image capturing device coupled to the UAGV, of the reported issue at the location in the facility. The UAGV can transmit the image to the computing system to confirm the type of the facility issue based on the image captured by the UAGV. The computing system can transmit an appropriate alert after confirming the issue.

### CROSS-REFERENCE TO RELATED PATENT APPLICATIONS

This application claims priority to U.S. Provisional Application No. 62/459,876 filed on Feb. 16, 2017, and U.S. Provisional Application No. 62/467,510 filed on Mar. 6, 2017, the content of each is hereby incorporated by reference in its entirety.

### BACKGROUND

A facility can experience issues during the course of operation. The issues may take many forms such as issues relating to personal security, physical hazards, product conditions, product availability and other conditions. Before the issues can be addressed they must first be identified.

### BRIEF DESCRIPTION OF DRAWINGS

Illustrative embodiments are shown by way of example in the accompanying drawings and should not be considered as a limitation of the present disclosure:

FIGS. 1A-F illustrate an exemplary user interface of a mobile device in accordance with an embodiment;

FIG. 2 is a block diagram illustrating an exemplary autonomous Unmanned Aerial/Ground Vehicle (UAGV) in an embodiment;

FIG. 3 is a block diagram illustrating an exemplary issue reporting and detection system in an embodiment;

FIG. 4 is a block diagram illustrating of an exemplary computing device suitable for use in an embodiment; and

FIG. 5 is a flowchart illustrating an exemplary process performed by an issue reporting and detection system in accordance with an embodiment;

### DETAILED DESCRIPTION

Described in detail herein is an issue reporting and detection system. A user can capture an image of an issue at a location in a facility using an image capturing device integrated with the user's mobile device. An application executing on the mobile device can receive a user provided input associated with the image and transmit the image and the input associated with the image to a computing system associated with the facility from the user's mobile device. The computing system can receive the image and the input associated with the image and can extract a set of attributes from the image. As explained further below, the computing system can analyze the image to extract attributes such as product bar codes, shelf or other facility identifiers or some other type of attribute that can be used to determine a location in the facility. The computing system can query the issues types database to retrieve a type of facility issue using the input associated with the image. The computing system can determine a location at which the image was taken in the facility based on the set of attributes and can then transmit a command, based on the type of facility issue, to a selected Unmanned Aerial/Ground Vehicle (UAGV) to navigate to the determined location of the facility. In one embodiment the selected UAGV is one of a group of UAGVs available in the facility and may be selected based on proximity to the determined location. In another embodiment, the selected UAGV may be selected based on remaining battery life or other criteria. The selected UAGV can capture an image using am image capturing device coupled to the UAGV, of the reported issue at the location in the facility. The selected UAGV can transmit the image to the computing system. The computing system is further configured to extract a set of attributes from the image captured by the image capturing device coupled to the UAGV in order to confirm the type of the facility issue based on the extracted set of attributes. The computing system may also transmit an alert in response to confirming the type of facility issue. In one embodiment the alert may be directed to an authorized individual at the facility to address the determined issue. For example, if the issue is missing product or broken glass, the alert may be sent to an employee able to replace product or clean up the broken glass. In another embodiment, instead of alerting an employee, the computing system may transmit an alert to a UAGV with ground-based navigational capability that also has the ability to dispose of broken glass. In an embodiment, the UAGV that is alerted may be the same UAGV that captured an image to confirm the type of issue.

As used herein the term “UAGV” should be understood to encompass unmanned vehicles having either or both of ground-based or aerial based navigational capability. It will be appreciated that certain tasks as described herein will be appropriately performed by vehicles that are primarily land-based such as, but not limited to, picking up hazards, stocking shelves, moving objects to their correct locations, and certain other tasks may be more appropriate for aerial-based vehicles such as, but not limited to, scanning for issues, reconnaissance of user reported issues and searching for sources of hazards to feed the information to a ground-based UAGV. It should further be appreciated that some tasks may be performed by UAGVs regardless of whether their primary navigation mode is ground-based or aerial-based.

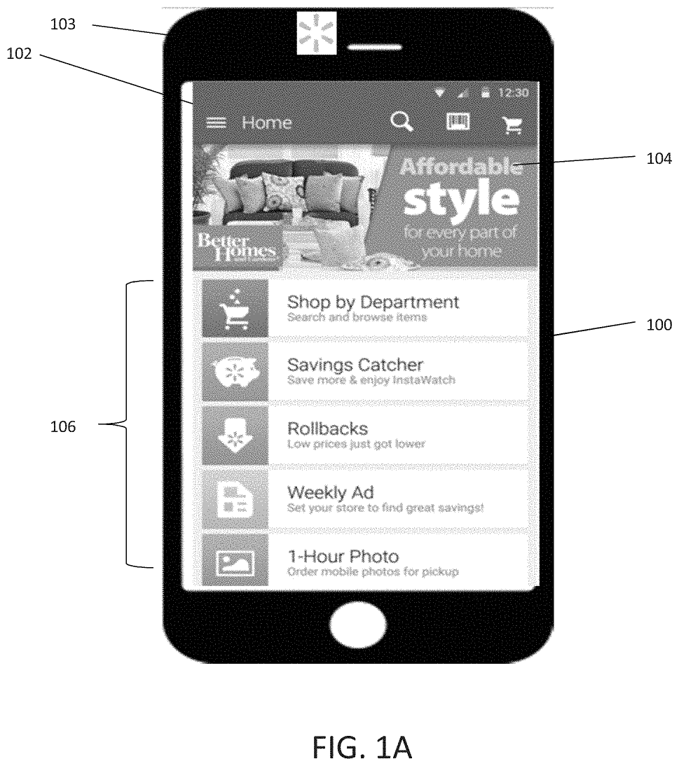

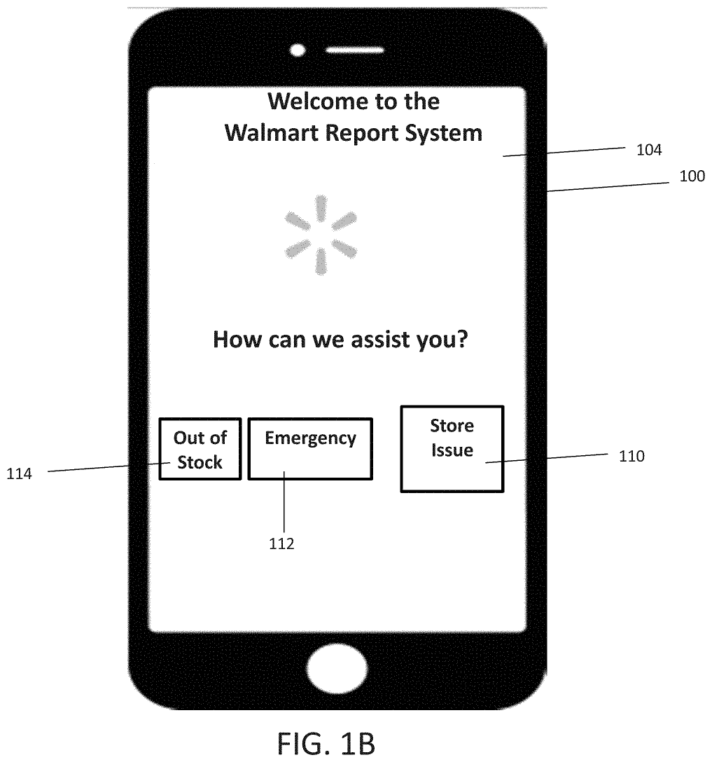

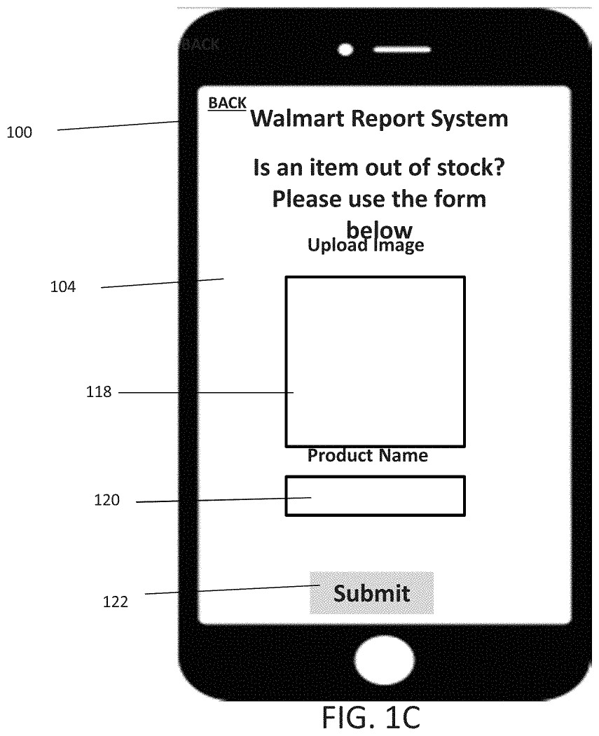

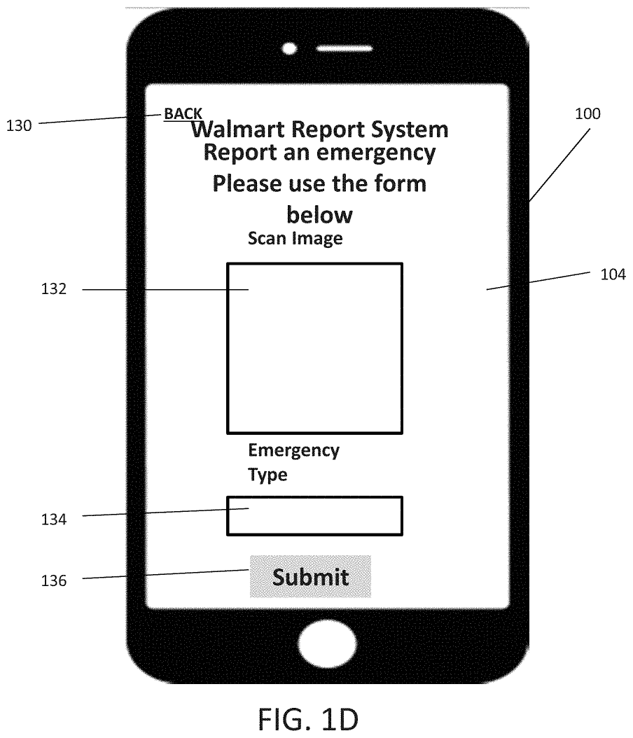

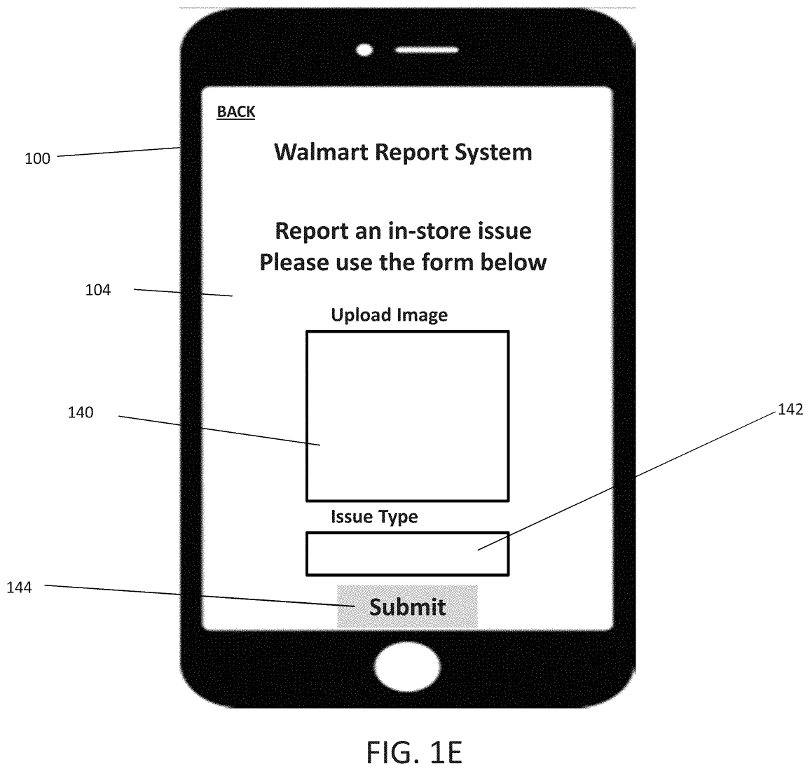

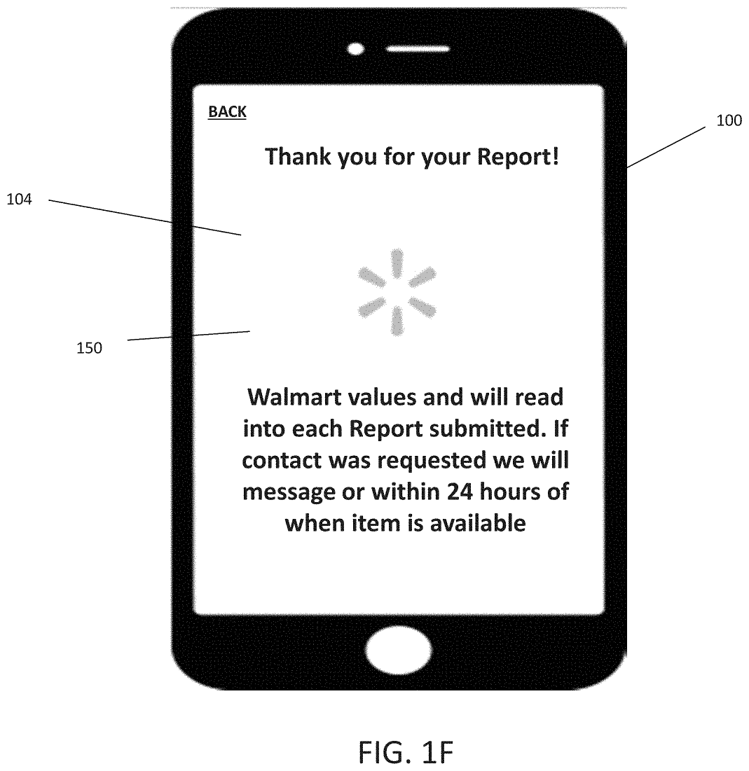

FIGS. 1A-F illustrate exemplary user interfaces of a mobile device in an exemplary embodiment. With reference to FIG. 1A, a mobile device 100 can include a display 102, an image capturing device 103 and the display 102 can display a user interface 104. A user can operate the mobile device 100 in a facility. The user interface 104 can automatically be generated in response executing an application on the mobile device 100. The application can be associated with the facility. The user interface 104 can display various selections 106 associated with the facility. Each of the selections 106 may correspond with different actions within the facility. One of the selections 106 can trigger an action to report an issue within the facility. The image capturing device 103 can be configured to capture still and moving images and can communicate with the executing application.

With reference to FIG. 1B, in response to selecting an option to report an issue with the facility, an initial screen can be displayed on the user interface 104 of the mobile device 100. In one embodiment, the initial screen can include a selection to report a number of facility issues such as store issue 110, an emergency 112, or an out of stock physical object 114. The store issue can be, but is not limited to, reporting that not enough associates are in a specific location of a facility, reporting that there are broken fixtures in the facility, reporting that there are decomposing or damaged physical objects disposed in the facility or any other type of assistance that may be needed in the facility. The emergency 112 can be, but is not limited to reporting a fire, reporting a medical emergency, reporting a theft, reporting broken glass or any other dangerous physical condition within the facility, or reporting a security personal security problem. The out of stock selection can be missing physical objects in a designated location of the facility. The user can trigger an action by selecting any of these selections. It will be appreciated that in one embodiment the user interface may combine these selections into a fewer number of selection options for handling than illustrated in FIG. 1B. Similarly in another embodiment, additional or alternative selection options may be provided through the user interface 104.

With reference to FIG. 1C, in response to selecting the out of stock selection, in one embodiment a reporting out of stock item screen can be displayed on the user interface 104 of the mobile device 100. As mentioned above, the out of stock selection can be used to report missing physical objects in the facility. The reporting out of stock item screen can include an upload photo input box 118, a product name input box 120, and a submit button. The user can select the upload photo input box 118 by interacting with the upload photo input box 118. In some embodiments, the user can touch the area within the upload photo input box 118 using their digits, and the image capturing device (as shown in FIG. 1A) can automatically be executed. The user can capture an image in response to the image capturing device being executed. Alternatively, the user can touch the upload photo input box 118 and the user interface 104 will display a stored photo library section of the mobile device 100 for a selection of a stored photo. It should be appreciated that a user can use their fingers to touch other locations within the input photo box to either execute the image capturing device or display the stored photo library. It will further be appreciated the user can interact with the upload photo input box using other input devices such as a keyboard and mouse.

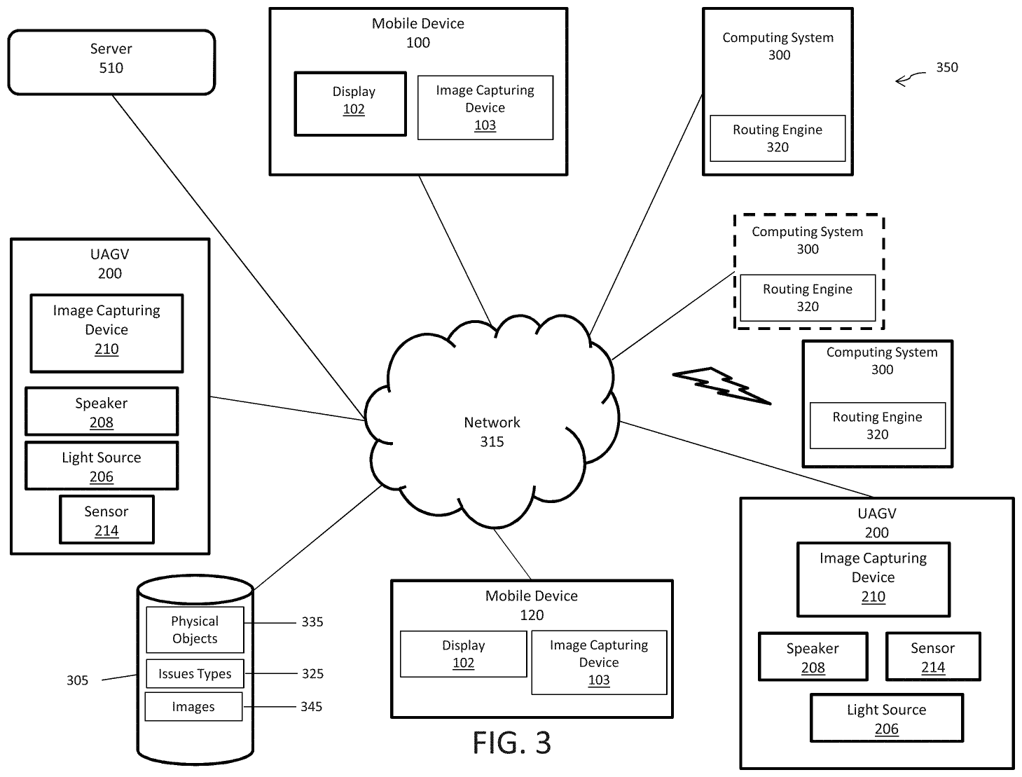

Once a user either captures an image or selects an image from the stored photo library, the mobile application displays the image within the upload photo input box. The image can be a photo of a location within the facility in which the missing physical object is designated to be disposed. The image can include information such as an machine-readable element encoded with an identifier associated with the physical object, or a neighboring physical object. In some embodiments, the size of the image will be reduced so that it can fit into the upload photo input box 118. The user can crop and/or move the image within the upload photo input box 118. The user can enter a name of the missing physical object in the product name input box 120. The product name input box 120 may accept alphanumeric input. Once the user has uploaded the image in the upload photo input box 118 and entered the name of the missing physical object 118, the user can select the submit button 120. In response to selecting the submit button, the image and the name of the physical object can be transmitted to a computing system 300. The computing system 300 will be discussed in further detail with reference to FIG. 3.

With reference to FIG. 1D, in one embodiment, in response to selecting the emergency selection a reporting an emergency screen can be displayed on the user interface 104 of the mobile device 100. As mentioned above, the emergency selection can be used to report a fire, accident, medical emergency, broken glass, spills, and/or any other dangerous condition in the facility. The reporting emergency screen can include a scan/upload photo input box 132, an emergency name input box 134, and a submit button 136. The user can select the scan/upload photo input box 136 by interacting with the upload photo input box 136. In some embodiments, the user can touch the area within the upload photo input box 136 using their fingers, and the image capturing device (e.g.: as shown in FIG. 1A) can automatically be executed. The user can capture an image in response to the image capturing device being executed. Alternatively, the user can touch the upload photo input box 136 and the user interface 104 will display a stored photo library section of the mobile device 100 for a selection of a stored photo. It can be appreciated that a user can use their fingers to touch other locations within the input photo box to either execute the image capturing device or display the stored photo library. It will further be appreciated the user can interact with the upload photo input box using other input devices such as a keyboard and mouse.

Once a user either captures an image or selects an image from the stored photo library, the mobile application may display the image within the upload photo input box. The image can be a photo of a location within the facility of the emergency. The image can include the actual emergency. The image can also include information within the image to indicate the location of the image, such as an machine-readable element encoded with an identifier associated with a physical object disposed at the location or some sort of landmark at the location. In some embodiments, the size of the image will be reduced so that it can fit into the upload photo input box 132. The user can crop and/or move the image within the upload photo input box 132. The user can enter input attempting to describe the emergency in the emergency type input box 134. The emergency type input box 134 may accept alphanumeric input. In some embodiments, the each emergency can have a specific alphanumeric code/identifier. Once the image appears in the upload photo input box 134 and entered the type of emergency, the user can select the submit button 134. In response to selecting the submit button, the image and the input regarding the type of emergency can be transmitted to a computing system 300. The computing system 300 will be discussed in further detail with reference to FIG. 3.

With reference to FIG. 1E, in one embodiment, in response to selecting the store issue selection, a reporting a store issue screen can be displayed on the user interface 104 of the mobile device 100. As mentioned above, the store issue selection can be used to report one or more of not enough associates in a specific location of a facility, broken fixtures in the facility, decomposing or damaged physical objects disposed in the facility or any other type of assistance that may be needed in the facility. The reporting store issue screen can include an upload photo input box 140, an issue type input box 142, and a submit button 142. The user can select the scan/upload photo input box 140 by interacting with the upload photo input box 140. In some embodiments, the user can touch the area within the upload photo input box 140 using their fingers, and the image capturing device (e.g.: as shown in FIG. 1A) can automatically be executed. The user can capture an image in response to the image capturing device being executed. Alternatively, the user can touch the upload photo input box 140 and the user interface 104 will display a stored photo library section of the mobile device 100 for a selection of a stored photo. It can be appreciated that a user can use their fingers to touch other locations within the input photo box to either execute the image capturing device or display the stored photo library. It will further be appreciated the user can interact with the upload photo input box using other input devices such as a keyboard and mouse.

Once user either captures an image or selects an image from the stored photo library, the mobile application can display the image within the upload photo input box. The image can be a photo of a location within the facility where there is an in-store issue. The image can include the in-store issue. The image can also include information within the image to indicate the location of the image, such as an machine-readable element encoded with an identifier associated with a physical object disposed at the location or some sort of landmark at the location. In some embodiments, the size of the image will be reduced so that it can fit into the upload photo input box 140. The user can crop and/or move the image within the upload photo input box 140. The user can enter text regarding the issue type box 142. The issue type input box 142 may accept alphanumeric input. In some embodiments, the each issue can have a specific alphanumeric code/identifier. Once the image appears in the upload photo input box 140 and the user has entered input regarding the type of issue, the user can select the submit button 144. In response to selecting the submit button, the image and the type of issue can be transmitted to a computing system 300. The computing system 300 will be discussed in further detail with reference to FIG. 3.

With further reference to FIG. 1F, in one embodiment a confirmation screen 150 can be displayed on the user interface 104 of the mobile device 100 once any facility issue is submitted. The confirmation page 150 includes a confirmation that the facility issue was reported and transmitted to the computing system. The confirmation page 150 also indicates the user will receive a message regarding the facility issue reported within 24 hours. The message can be transmitted to the user via the application executed on the mobile device 100 associated with the facility.

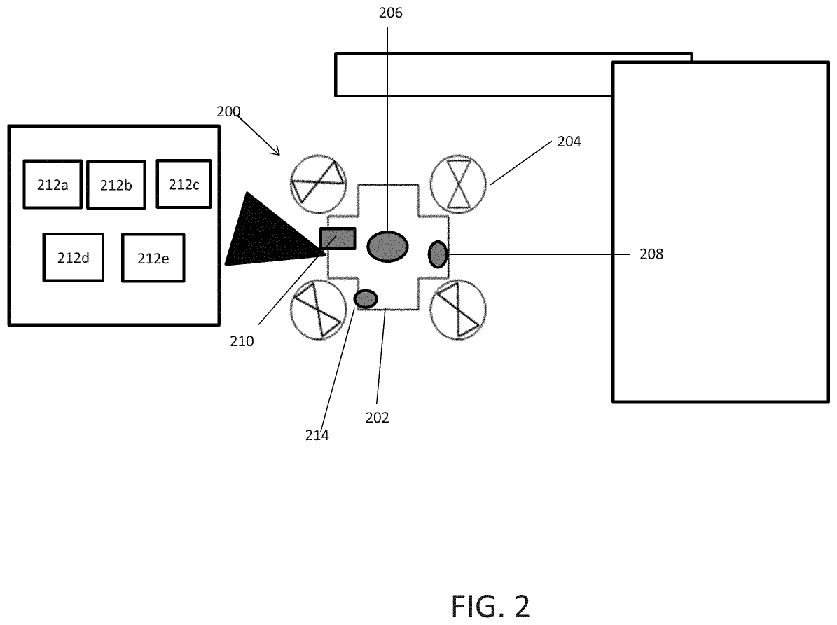

FIG. 2 is a block diagram illustrating an exemplary autonomous Unmanned Aerial/Ground Vehicle (UAGV) in an embodiment. The autonomous UAGV 200 includes an inertial navigation system. The autonomous UAGV can autonomously navigate either aerially or on the ground using motive assemblies 204. The UAGV 200 can include a body 210 and multiple motive assemblies 204. In this non-limiting example, the motive assemblies can be secured to the body on the edges of the UAGV 200.

The UAGV 200 can include a speaker system 206, a light source 208 and an image capturing device 210. The image capturing device 210 can be configured to capture still or moving images. The light source 208 can be configured to generate various types of lights and generate various effects using the light. The speaker system 206 can be configured to generate audible sounds. The UAGV 200 can include a controller 212a, and the inertial navigation system can include a GPS receiver 212b, accelerometer 212c and a gyroscope 212d. The UAGV 200 can also include a motor 212e. The controller 212a can be programmed to control the operation of the image capturing device 210, the GPS receiver 212b, accelerometer 212c, a gyroscope 212d, motor 212e, and drive assemblies 212 (e.g., via the motor 212e), in response to various inputs including inputs from the GPS receiver 212b, the accelerometer 212c, and the gyroscope 212d. The motor 212e can control the operation of the motive assemblies 204 directly and/or through one or more drive trains (e.g., gear assemblies and/or belts). The motive assemblies 204 can be but are not limited to wheels, tracks, rotors, rotors with blades, and propellers.

The GPS receiver 212b can be a L-band radio processor capable of solving navigation equations in order to determine a position of the UAGV 200 and to determine a velocity and precise time (PVT) by processing a signal broadcast by GPS satellites. The accelerometer 212c and gyroscope 212d can determine the direction, orientation, position, acceleration, velocity, tilt, pitch, yaw, and roll of the UAGV 200. In exemplary embodiments, the controller can implement one or more algorithms, such as a Kalman filter, for determining a position of the UAGV 200.

In one embodiment, the UAGV 200 can also include a sensor 214. The sensor 214 can be one or more of a moisture sensor, ultraviolet light sensor, or an molecular scanner. In the event the sensor 214 is a moisture sensor, the sensor can detect moisture emitted by physical objects. In the event the sensor 214 is an ultraviolet light sensor, the sensor 214 can be configured to detect ultraviolet light in a facility. In the event the sensor is an 214 is a molecular scanner, the sensor 214 can use a near-IR spectroscopy method to determine the contents of a physical object. The interaction of the vibration of molecules can be detected and referenced to a database of molecular compositions and vibrations. Using the detected vibration of the molecules can determine the contents of a physical object. As a non-limiting example, molecular scanners can be used for determining the contents of the following physical objects: pharmaceuticals, food, beverages, art, collectibles, and jewelry.

In exemplary embodiments, the autonomous UAGV 200 may receive instructions from the computing system 300 to confirm an issue which has been reported as described in FIGS. 1A-F. The details of the confirmation process will be discussed in further detail with respect to FIG. 3.

FIG. 3 is a block diagram illustrating an issue reporting and confirmation system 350 according to an exemplary embodiment. The issue reporting and confirmation system 350 can include one or more databases 305, one or more servers 310, one or more computing systems 300, mobile devices 100 and UAGVs 200. The UAGVs 200 can include a speaker system 206, a light source 208, an image capturing device 210, and a sensor 214. The image capturing device 210 can be configured to capture still and moving images. The light source 208 can be configured to generate light effects. The speaker system 206 can be configured to generate audible sounds. The mobile devices 100 can include an interactive display 102. In exemplary embodiments, the computing system 300 can be in communication with the databases 305, the server(s) 310, the mobile devices 100, and the UAGVs 200, via a communications network 315. The computing system 300 can implement at least one instance of a routing engine 320. The routing engine 320 is an executable application executed by the computing system 300. The routing engine 320 can implement the process of the issue reporting and confirmation system 350. The routing engine 320 will be described in detail herein.

In an example embodiment, one or more portions of the communications network 315 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 300 includes one or more computers or processors configured to communicate with the databases 305, the mobile devices 100 and the UAGVs 200 via the network 315. In one embodiment, computing system 300 is associated with a facility. The computing system 300 hosts one or more applications configured to interact with one or more components of the issue reporting and confirmation system 350. The databases 305 may store information/data, as described herein. For example, the databases 305 can include an images database 345, a physical objects database 335 and an issue types database 325. The image database 345 can store images captured by the image capturing device 210 of the UAGVs 200 and/or images captured by the user on their mobile device. The physical objects database 335 can store information associated with physical objects. The issues types database 325 can include types of issues related to facilities and types of emergencies. The issues type database 325 can include alphanumeric codes and/or identifiers of types of issues. The databases 305 and server 310 can be located at one or more geographically distributed locations from each other or from the computing system 300. Alternatively, the databases 305 can be included within server 310 or computing system 300.

In exemplary embodiments, a user can discover an issue in a facility. For example, the issue can be a missing physical object, an issue associated with the facility or an emergency. In the event the issue is a missing physical object, a physical object can be missing from a designated location within the facility. Exemplary issues associated with a facility can be, but are not limited to, one or more of a need for more associates in a certain location, a broken fixture in the facility, damaged or decomposing products and/or other assistance needed in the facility. Exemplary emergencies can be, but are not limited to, one or more of a fire, a spill, broken glass, theft and/or any other dangerous condition in the facility. The user's mobile device 100 can execute an application associated with the facility. The application can display a user interface prompting the user to upload an image of the facility issue and enter input associated with the facility issue. In one embodiment, the mobile device 100 can automatically execute the image capturing device 103 in response to the user interacting with the user interface displayed by the executed application. The user can capture an image of the issue using the image capturing device 103 of their mobile device 100. Alternatively, the user can capture an image of the issue prior to executing the application and interaction with the user interface displayed by the application can automatically retrieve stored images so that the user can select at least one of the stored images corresponding with the issue. The user can upload the captured or selected image and enter input associated with the issue. For example, the user can enter alphanumeric input associated with the name of the missing physical object, the type of issue associated with the facility and/or the type of emergency. The user can submit the uploaded image and input associated with issue. The uploaded image and input associated with the issue can be transmitted to the computing system 300.

The computing system 300 can execute the routing engine 320 in response to receiving the image and the input associated with the image. The routing engine 320 can extract a set of attributes from the image using video analytics and/or machine vision. The routing engine 320 can determine the location of the issue within the facility based on the extracted set of attributes. For example, the extracted set of attributes can include a machine-readable element encoded with an identifier of a physical object designated to be disposed in the facility. The routing engine 320 can extract the machine readable element and decode the identifier associated with the machine-readable element from the image. The routing engine 320 can query the physical objects database 335 using an identifier, to determine the location at which the physical object is designated to be disposed in the facility. In some embodiments, the routing engine 320 can extract a landmark from the image to determine the location of the reported issue. The routing engine 320 can query the issue types database 325 using the input associated with image to determine the type of facility issue. In some embodiments, the user input will match a stored type of issue. In other embodiments, the input will be parsed based on pre-defined criteria (e.g.: keywords) to determine the type of issue the user is attempting to report. In one embodiment, in the event the issue is reporting a missing physical object, the routing engine 320 can query the physical objects database 335 using the input associated with the name of the missing physical object to determine the identification of the physical object.

The routing engine 320 can instruct a UAGV 200 to confirm the reported issue. In some embodiments, the routing engine 320 can detect a UAGV 200 within a specified threshold distance of the determined location of the issue and instruct the detected UAGV 200 to confirm the reported issue based on proximity. In another embodiment, the UAGV 200 may be selected based on other criteria such as battery life remaining or UAGV capabilities. The instructions can include the determined location, the image and the identification of the physical object and the determined type of facility issue.

The UAGV 200 can receive instructions from the routing engine 320 to confirm the reported issue. The UAGV 200 can navigate to the determined location. The UAGV 200 can capture an image of the location of the reported issue using the image capturing device 210. In some embodiments, the UAGV 200 can capture multiple images of the location of the reported issues. The UAGV 200 can transmit the images to the computing system 300. In some embodiments, the UAGV 200 can scan the location using the image capturing device 210 to detect the issue based on the received facility issue type.

The computing system 300 can receive the images from the UAGV 200. The routing engine 320 can extract attributes from the images captured by the UAGV 200. The routing engine 320 can query the images database 345 to retrieve the image received by the user. The routing engine 320 can perform video analysis of the image received from the UAGV to extract attributes from the image. In one embodiment the routing engine can compare the extracted attributes of the images received from the UAGV 200 and the extracted attributes from the image received from the user. In another embodiment, the image from the UAGV may be analyzed to detect an issue without relying on the image received from the user. The routing engine 320 can confirm the reported issue following analysis of the second image received from the UAGV.

In one embodiment, in the event, the reported issue is associated with a missing physical object and the routing engine 320 is able to confirm the physical object is missing from the designated location within the facility the computing system 320 can transmit an alert to an authorized individual in the facility.

In another embodiment, the routing engine 320 can instruct the UAGV 200 to retrieve and deposit like physical objects in the designated location of the missing physical object within the facility. The routing engine can query the physical objects database 335 to determine a location of the like physical objects are disposed in a location other than the designated location within the facility and provide the information to the UAGV 200. The UAGV 200 can navigate to the location, pick-up a specified quantity of like physical objects and carry the like physical objects to the designated location. The UAGV 200 can deposit the like physical objects in the designated location. The UAGV 200 can update the physical objects database 335 based on the specified quantity of like physical objects deposited in the designated location. The UAGV 200 can also transmit an alert to the routing engine indicating that it has deposited like physical objects in the designated location. The routing engine 320 can transmit an alert to the mobile device 100 indicating the deposited like physical objects. The mobile device 100 can display the alert on the display 102. In some embodiments, the alert can be displayed on the user interface displayed by the application.

In an embodiment, the UAGV 200 may notice that items in the facility are misplaced such as being in a wrong shelf location or located on the floor in a facility aisle. The UAGV can inform the routing engine of a misplaced item, receive an assigned location for the misplaced item from the routing engine following the routing engine's query of the physical objects database 335, retrieve the misplaced item and replace the misplaced item in its assigned location. In some cases this replacing of the misplaced item may require the UAGV 200 to place an item into a different location on a same shelf. In other circumstances, the UAGV 200 may need to navigate large distances in the facility to perform the replacement operation.

In one embodiment, upon items being confirmed as being missing by a UAGV, the routing engine can query the physical objects database 335 to determine where like physical objects are disposed in a location other than the designated location within the facility. If no alternate location within the facility is found, the routing engine may programmatically initiate a resupply order of a quantity of the missing items from a facility supplier for delivery to the facility.

In one embodiment, in the event the issue is an emergency, and the routing engine 320 is able to confirm the emergency in the location within the facility the routing engine 320 can transmit an alert. The routing engine 320 can also instruct the UAGV 200 to sound an alarm at the location of the emergency. For example, UAGV 200 may generate a light effect using the light source 206 and generate audible sounds using the speaker system 208 at the location of the emergency in response to receiving the instructions.

In one embodiment, in the event the issue is an issue associated with the facility and the routing engine 320 is able to confirm the issue associated with the facility at the location within the facility the routing engine 320 can transmit an alert. In a non-limiting example, the routing engine 320 can transmit an alert to a mobile device of an associate working within the facility.

As described above, in one embodiment, the UAGV 200 can also include a sensor 214. The sensor 214 can be one or more of a moisture sensor, ultraviolet light sensor, molecular scanner, or provide an X-ray capability. In the event the sensor 214 is a moisture sensor, the sensor can detect moisture emitted by physical objects. In the event the sensor 214 is an ultraviolet light sensor, the sensor 214 can be configured to detect ultraviolet light in a facility. In the event the sensor is an 214 is a molecular scanner, the sensor 214 can use a near-IR spectroscopy method to determine the contents of a physical object. The interaction of the vibration of molecules can be detected and referenced to a database of molecular compositions and vibrations. Using the detected vibration of the molecules can determine the contents of a physical object can be determined. As a non-limiting example, molecular scanners can be used for determining the contents of the following physical objects: pharmaceuticals, food, beverages, art, collectibles, and jewelry. In the event the sensor 214 provides an X-ray capability, the sensor 214 can take an X-ray to view the insides of physical objects to determine the state of the physical objects. The sensor 214 can detect broken, damaged, spoiled, deteriorating, degenerating, decaying, or decomposing physical objects in the facility. In response to detecting broken, damaged, spoiled, deteriorating, degenerating, decaying, or decomposing physical objects in the facility, image capturing device 210 can capture an image of the damaged, spoiled, deteriorating, degenerating, decaying, or decomposing physical objects in the facility and transmit the image to the computing system 300. The computing system 300 can receive the image and the routing engine 320 can instruct the UAGV 200 to take remedial measures. For example, the routing engine 320 can instruct the UAGV 200 clean up a broken physical object, replace the damaged physical objects, and/or transmit an alert regarding the broken/damaged physical objects.

As a non-limiting example, the issue reporting and confirmation system 350 can be implemented in a retail store. A customer can travel around the retail store and report an issue within the retail store using a mobile application associated with the retail store that is executed on the customer's smartphone or other mobile device.

As noted above, the routing engine 320 can extract a set of attributes from an image using video analytics and/or machine vision. The types of machine vision and/or video analytics used by the routing engine 320 can be but are not limited to: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology. The routing engine 320 determine the location of the issue within the facility based on the extracted set of attributes.

As noted above, the UAGV 200 can capture an image of the location of the reported issue using the image capturing device 210. In some embodiments, the UAGV 200 can capture multiple images of the location of the reported issues.

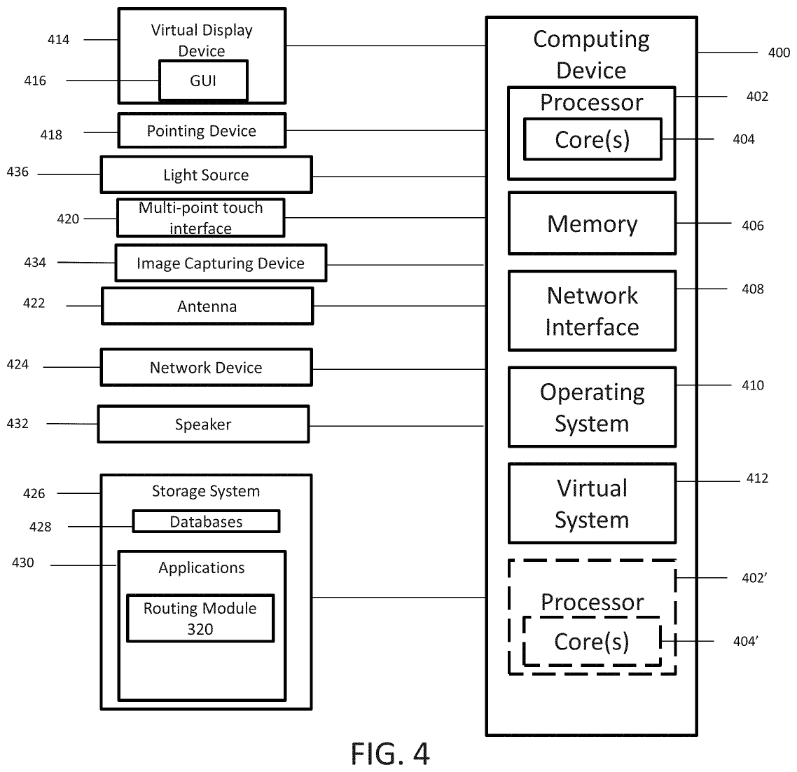

FIG. 4 is a block diagram of an example computing device suitable for use in an embodiment. In one embodiment, computing device 400 can execute the routing engine. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 406 included in the computing device 400 may store computer-readable and computer-executable instructions or software (e.g., applications 430 such as the routing engine 320) for implementing exemplary operations of the computing device 400. The computing device 400 also includes configurable and/or programmable processor 402 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for implementing exemplary embodiments of the present disclosure. Processor 402 and processor(s) 402′ may each be a single core processor or multiple core (404 and 404′) processor. Either or both of processor 402 and processor(s) 402′ may be configured to execute one or more of the instructions described in connection with computing device 400.

Virtualization may be employed in the computing device 400 so that infrastructure and resources in the computing device 400 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof.

A user may interact with the computing device 400 through a visual display device 414, such as a computer monitor, which may display one or more graphical user interfaces 416, multi touch interface 420, a pointing device 418, and image capturing device 434. The image capturing device 434 can be configured to capture still or moving images. The light source 436 can be configured to generate light effects. The speakers 432 can be configured to generate audible sounds.

The computing device 400 may also include one or more storage devices 426, such as a hard-drive, CD-ROM, or other computer readable media, for storing data and computer-readable instructions and/or software that implement exemplary embodiments of the present disclosure (e.g., applications such as the routing engine 420). For example, exemplary storage device 426 can include one or more databases 428 for storing information associated information associated with physical objects, captured images and information associated with issue types. The databases 428 may be updated manually or automatically at any suitable time to add, delete, and/or update one or more data items in the databases.

The computing device 400 can include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 422 to facilitate wireless communication (e.g., via the network interface) between the computing device 600 and a network and/or between the computing device 400 and other computing devices. The network interface 608 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run any operating system 410, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 400 and performing the operations described herein. In exemplary embodiments, the operating system 410 may be run in native mode or emulated mode. In an exemplary embodiment, the operating system 410 may be run on one or more cloud machine instances.

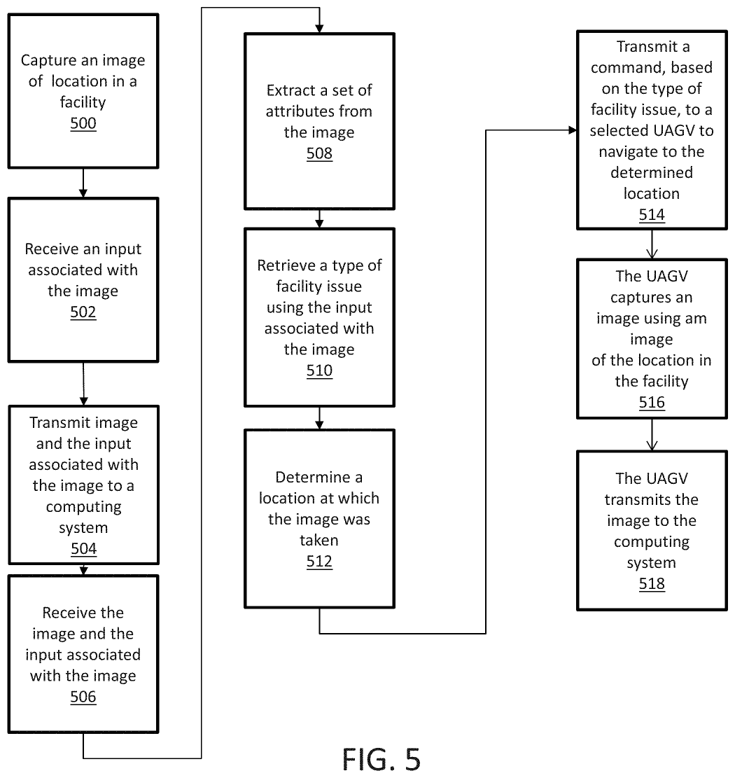

FIG. 5 is a flowchart illustrating an exemplary process performed by an issue reporting and confirmation system in an exemplary embodiment. In operation 500, a user can capture an image of a location in a facility, using an image capturing device (e.g. image capturing device 103 as shown in FIGS. 1A and 3) integrated with the user's mobile device (e.g. mobile device 100 as shown in FIGS. 1A-F and 3). The user can execute an application on the mobile device. In operation 502, the application executing on the mobile device can receive an input associated with the image. In operation 504, the mobile application can transmit the captured image and the input associated with the image to a computing system (e.g. computing system 300 as shown in FIG. 3) associated with the facility from the user's mobile device. In operation 506, the computing system can receive the image and the input associated with the image. In operation 508, the computing system can extract a set of attributes from the image. In operation 510, the computing system can query the issues types database (e.g. issues types database 325 as shown in FIG. 3) to retrieve a type of facility issue using the input associated with the image. In operation 512, the computing system can determine a location at which the image was taken in the facility based on the set of attributes. In operation 514, the computing system can transmit a command, based on the type of facility issue, to a selected UAGV to navigate to the determined location of the facility. In operation 516 the selected UAGV (e.g. the selected UAGV 200 as shown in FIGS. 2 and 3) can capture an image using am image capturing device (e.g. image capturing device 210 as shown in FIGS. 2 and 3) coupled to the UAGV, at the location in the facility of the reported issue. In operation 518, the selected UAGV can transmit the image to the computing system. The computing system is further configured to extract a set of attributes from the image captured by the image capturing device coupled to the UAGV, confirm the type of the facility issue based on the extracted set of attributes, and transmit an alert in response to confirming the type of facility issue.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A Unmanned Aerial/Ground Vehicle (UAGV) detection system in a facility, the system comprising:
a mobile application configured to execute on a user's mobile device and to:
capture a first image in a first location in a facility using an image capturing device integrated with the user's mobile device,
receive an input associated with the first image, and
transmit the first image and the input associated with the first image to a computing system associated with the facility;
the computing system associated with the facility, the computing system configured to:
receive the first image and the input associated with the first image,
extract a first set of attributes from the first image,
determine a first location at which the first image was taken in the facility based on the set of attributes,
query a database to identify a type of facility issue using the input associated with the first image, and
transmit a command, based on the type of facility issue, to a selected UAGV to navigate to the determined first location of the facility; and
the selected UAGV that includes an inertial navigation system and a second image capturing device and is configured to:
capture a second image of the first location in the facility using the second image capturing device,
transmit the second image to the computing system associated with the facility, and
receive an instruction from the computing system to take remedial measures to resolve the facility issue following the computing system confirming a type of the facility issue based on a second set of attributes extracted from the second image.

2. The system of claim 1, wherein the facility issue is one or more of: a spill, a breakage of glass, a slippery floor, a fire, a damaged or decomposing physical object, a missing physical object and a physical object in an incorrect location.

3. The system of claim 1, wherein the first set of attributes can include at least one physical object disposed in the facility.

4. The system of claim 3, wherein the selected UAGV is configured to:
query the database to retrieve an object location of the physical object in the facility; and
determine the first location based on the object location.

5. The system of claim 1 wherein the facility issue is a missing set of like physical objects from a shelving unit in facility.

6. The system of claim 5, wherein the selected UAGV is further configured to:
query the database to determine whether a specified quantity of like physical objects are disposed in a second location of the facility;
navigate to the second location of the facility in response to determining the specified quantity of the like physical objects are disposed in a second location in the facility;
pick-up the specified quantity of the like physical objects from the second location of the facility;
carry the specified quantity of the like physical objects to the first location; and
place the specified quantity of like physical objects on the shelving unit.

7. The system of claim 6, wherein the selected UAGV is further configured to:
update the database based on the specified quantity of the like physical objects picked up from the second location of the facility.

8. The system of claim 1, wherein the facility issue is a missing set of like physical objects from a shelving unit in the facility, and in response to a determination that the specified quantity of the like physical objects are unavailable in a second location in the facility, the computing system is further configured to:
automatically order a replacement supply of the like physical objects from a supplier for delivery to the facility.

9. The system of claim 1, wherein the computing system extracts the first and second set of attributes using video analytics.

10. A Unmanned Aerial/Ground Vehicle (UAGV) detection method in a facility, the method comprising:
capturing, via a mobile application configured to execute on a user's mobile device, a first image in a first location in a facility using an image capturing device integrated with the user's mobile device;
receiving, via the mobile application, an input associated with the first image;
transmitting, via the mobile application, the first image and the input associated with the first image to a computing system associated with the facility from the user's mobile device;
receiving, via the computing system associated with the facility, the first image and the input associated with the first image;
extracting, via the computing system, a first set of attributes from the first image;
determining, via the computing system, a first location at which the first image was taken in the facility based on the set of attributes;
querying, via the computing system, a database to identify and retrieve a type of facility issue using the input associated with the first image;
transmitting, via the computing system, a command, based on the type of facility issue, to a selected UAGV to navigate to the determined first location of the facility;
capturing, via the selected UAGV that includes an inertial navigation system and a second image capturing device, a second image of the first location in the facility using the second image capturing device;
transmitting, via the selected UAGV, the second image to the computing system associated with the facility, and
receiving an instruction from the computing system to take remedial measures to resolve the facility issue following the computing system confirming a type of the facility issue based on a second set of attributes extracted from the second image.

11. The method of claim 10, wherein the facility issue is one or more of: a spill, a breakage of glass, a slippery floor, a fire, a damaged or decomposing physical object, a missing physical object and a physical object in an incorrect location.

12. The method of claim 10, wherein the first set of attributes can include at least one physical object disposed in the facility.

13. The method of claim 12, further comprising:
querying, via the selected UAGV, the database to retrieve an object location of the physical object in the facility; and
determining, via the selected UAGV, the first location based on the object location.

14. The method of claim 10, wherein the facility issue is a missing set of like physical objects from a shelving unit in facility.

15. The method of claim 14, further comprising:
querying, via the selected UAGV, the database to determine whether a specified quantity of like physical objects are disposed in a second location of the facility;
navigating, via the selected UAGV, to the second location of the facility in response to determining the specified quantity of the like physical objects are disposed in a second location in the facility;
picking-up, via the selected UAGV, the specified quantity of the like physical objects from the second location of the facility;
carrying, via the selected UAGV, the specified quantity of the like physical objects to the first location; and
placing, via the selected UAGV, the specified quantity of like physical objects on the shelving unit.

16. The method of 15, further comprising:
updating, via the selected UAGV, the database based on the specified quantity of the like physical objects picked up from the second location of the facility.

17. The method of claim 10 wherein the facility issue is a missing set of like physical objects from a shelving unit in the facility, the method further comprising:
determining with the computing system that the specified quantity of the like physical objects is unavailable in a second location in the facility; and
ordering automatically with the computer system a replacement supply of the like physical objects from a supplier for delivery to the facility.

18. The method of claim 10, wherein the computing system extracts the first and second set of attributes using video analytics.

19. A Unmanned Aerial/Ground Vehicle (UAGV) detection system in a facility, the system comprising:
a mobile application configured to execute on a user's mobile device and to:
capture a first image in a first location in a facility using an image capturing device integrated with the user's mobile device,
receive an input associated with the first image, and
transmit the first image and the input associated with the first image to a computing system associated with the facility;
the computing system associated with the facility, the computing system configured to:
receive the first image and the input associated with the first image,
extract a first set of attributes from the first image,
determine a first location at which the first image was taken in the facility based on the set of attributes,
determine a type of facility issue based on the input associated with the first image,
select a UAGV that is within a specified threshold distance of the first location at which the first image was taken in the facility, and
transmit a command, based on the type of facility issue, to the selected UAGV to navigate to the determined first location of the facility;
the selected UAGV that includes an inertial navigation system, a second image capturing device and is configured to:
capture a second image of the first location in the facility using the second image capturing device, and
transmit the second image to the computing system associated with the facility,
wherein the computing system is further configured to extract a second set of attributes from the second image, confirm the type of the facility issue based on the second set of attributes, and transmit an alert in response to confirming the type of facility issue.
